(19) United States
(12) Patent Application Publication
(10) Pub. No.: US 2026/0088329 A1
(43) Pub. Date: Mar. 26, 2026

(54) ELECTRODE ASSEMBLY AND SECONDARY BATTERY HAVING THE SAME

(71) Applicant: SAMSUNG SDI CO., LTD., Yongin-si (KR)

(72) Inventor: Naoya MORISAWA, Yongin-si (KR)

(21) Appl. No.: 19/090,556

(22) Filed: Mar. 26, 2025

(30) Foreign Application Priority Data
Sep. 23, 2024 (KR) 10-2024-0128171

(51) Int. Cl. H01M 10/04; H01M 50/152

(52) U.S. Cl. CPC H01M 10/0431; H01M 10/0422; H01M 10/0468; H01M 50/152; H01M 2220/20

(57) ABSTRACT

An electrode assembly includes a first electrode plate, a separator, and a second electrode plate in a wound structure, the wound structure having a cylindrical shape, wherein a winding front end area is at a beginning of the wound structure, a winding rear end area is at an end of the wound structure, and a winding interval in the winding front end area is different from a winding interval in the winding rear end area.

### CROSS-REFERENCE TO RELATED APPLICATION

The present application claims priority to and the benefit of Korean Patent Application No. 10-2024-0128171, filed on Sep. 23, 2024, in the Korean Intellectual Property Office, the entire disclosure of which is incorporated herein by reference.

### BACKGROUND

### 1. Field

Embodiments relate to an electrode assembly and a secondary battery having the same.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

According to some embodiments, an electrode assembly configured to be wound in a cylindrical shape in a state in which a first electrode plate, a separator, and a second electrode plate are stacked, includes: a winding front end area on which winding of the first electrode plate, the separator, and the second electrode plate begin; and a winding rear end area on which the winding of the first electrode plate, the separator, and the second electrode plate are ended, wherein a winding interval in the winding front end area is different from a winding front end area in the winding rear end area.

The winding interval in the winding front end may be greater than the winding front end area in the winding rear end area.

The winding front end area may include about 1 turn to about 5 turns in a direction from a winding front end at which the winding begins to a winding end at which the winding is ended, and the winding rear end area may include about 1 turn to about 5 turns in a direction from the winding rear end at which the winding is ended to the winding front end at which the winding begins.

The winding interval may include a winding interval of the first electrode plate or a winding interval of the second electrode plate.

The first electrode plate may further protrude in one direction than the second electrode plate.

If, in a direction from a winding front end to a winding rear end, a winding interval between about 1 turn and about 2 turns is defined as d1, a winding interval between about 2 turns and about 3 turns is defined as d2, a winding interval between about 3 turns and about 4 turns is defined as d3, and a winding interval between about 4 turns and about 5 turns is defined as d4, and in a direction from the winding rear end to the winding front end, a winding interval between about 1 turn and about 2 turns is defined as d1-1, a winding interval between about 2 turns and about 3 turns is defined as d-2, a winding interval between about 3 turns and about 4 turns is defined as d-3, and a winding interval between about 4 turns and about 5 turns is defined as d-4, following mathematical equation: (d2+d3+d4)/(d-2+d-3+d-4)>1 may be satisfied.

A winding interval in the winding front end area may be about 340 μm to about 370 μm, and a winding interval in the winding rear end area may be about 320 μm to about 339 μm.

After a charge/discharge cycle of the electrode assembly, a height at the winding front end area may increase by about 0.5 mm to about 2 mm.

After a charge and discharge cycle of the electrode assembly, a perfect circle ratio in the winding front end area may be about 95% to about 99%.

A height of the winding front end area may be less than a height in the winding rear end area.

The electrode assembly may further include an insulating tape attached to an end of the winding front end area of the second electrode plate.

According to some embodiments, a secondary battery includes: an electrode assembly configured to be wound in a cylindrical shape in a state in which a first electrode plate, a separator, and a second electrode plate are stacked; a cylindrical case configured to accommodate the electrode assembly; and a cap assembly configured to seal the case, wherein the electrode assembly includes: a winding front end area on which winding of the first electrode plate, the separator, and the second electrode plate begin; and a winding rear end area on which the winding of the first electrode plate, the separator, and the second electrode plate are ended, wherein a winding interval in the winding front end area is different from a winding interval in the winding rear end area.

The first electrode plate may be electrically connected to the cap assembly through a first electrode tab, and the second electrode plate may be electrically connected to the case through a second electrode tab.

The cap assembly may include a cap-up, a safety vent coupled to the cap-up, a cap-down which is coupled to the safety vent and to which the first electrode tab is electrically connected, and an insulating gasket interposed between the cap-up, the safety vent, and the case.

The cap assembly may include a rivet terminal to which the first electrode tab is electrically connected, an insulating gasket coupled to the outside of the rivet terminal, and a cap plate coupled to the outside of the insulating gasket and coupled to the case.

The cap assembly may include a cap plate configured to cover a lower side of the case, the secondary battery may include a rivet terminal coupled by interposing an insulating gasket at an upper side of the case, and the first electrode plate may be electrically connected to the case through a first current collector plate, and the second electrode plate may be electrically connected to the rivet terminal through a second current collector plate.

According to some embodiments, a method for manufacturing a secondary battery includes: preparing an electrode assembly configured to be wound in a cylindrical shape in a state in which a first electrode plate, a separator, and a second electrode plate are stacked, wherein the electrode assembly includes a winding front end area on which winding of the first electrode plate, the separator, and the second electrode plate begin, and a winding rear end area on which the winding of the first electrode plate, the separator, and the second electrode plate are ended; accommodating the electrode assembly in a cylindrical case; inserting a pusher into the case to fix an upper end of the electrode assembly; pressing the upper end of the electrode assembly using the pusher, wherein a winding interval in the winding front end area is different from a winding interval in the winding rear end area.

The winding interval in the winding front end may be greater than the winding interval in the winding rear end area.

The winding front end area may include about 1 turn to about 5 turns in a direction from a winding front end at which the winding begins to a winding end at which the winding is ended, and the winding rear end area may include about 1 turn to about 5 turns in a direction from the winding rear end at which the winding is ended to the winding front end at which the winding begins.

### BRIEF DESCRIPTION OF THE DRAWINGS

Features will become apparent to those of skill in the art by describing in detail exemplary embodiments with reference to the attached drawings, in which:

FIG. 1 is a perspective view of an electrode assembly according to embodiments of the present disclosure;

FIG. 2 is a longitudinal cross-sectional view of an electrode assembly according to embodiments of the present disclosure;

FIG. 3 is a cross-sectional view illustrating a portion of the electrode assembly in a secondary battery according to embodiments of the present disclosure;

FIG. 4 is a schematic view illustrating a method for pressing the electrode assembly in the secondary battery according to embodiments of the present disclosure;

FIG. 5 is a cross-sectional view illustrating a portion of the electrode assembly in the secondary battery according to embodiments of the present disclosure;

FIG. 6 is a cross-sectional view illustrating a portion of the electrode assembly in a secondary battery according to embodiments of the present disclosure;

FIG. 7 is a perspective view of the secondary battery according to embodiments of the present disclosure;

FIG. 8 is a longitudinal cross-sectional view of FIG. 7;

FIG. 9 is an exploded perspective view of FIG. 7;

FIG. 10 is a perspective view of a secondary battery according to embodiments of the present disclosure;

FIG. 11 is a longitudinal cross-sectional view of FIG. 10;

FIG. 12 is a perspective view of a secondary battery according to further other embodiments of the present disclosure;

FIG. 13 is a longitudinal cross-sectional view of FIG. 12;

FIGS. 14 and 15 show a battery pack according to one or more embodiments of the present disclosure; and

FIGS. 16 and 17 show vehicle body parts and vehicle according to one or more embodiments of the present disclosure including the battery pack shown in FIGS. 14 and 15.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to be limiting of the present disclosure.

Currently, a secondary battery is required to have high capacity and high output characteristics due to its use in electric vehicles, etc. Thus, a content of silicon (Si) in a negative electrode increases, and a pressure applied to an electrode plate increases due to an increase in number of times of windings of an electrode assembly. For example, in case of a cylindrical secondary battery, a pressure applied to, particularly, an inner electrode plate having a large curvature or a risk of short circuit may increase due to an increase in length (height) of the electrode plate and core deformation of the electrode assembly. As a result, a gradual increase in capacity requires suppressing the core deformation of the electrode assembly according to a progress of a charging/discharging cycle, and preventing short circuit between the positive electrode plate and the negative electrode plate from occurring.

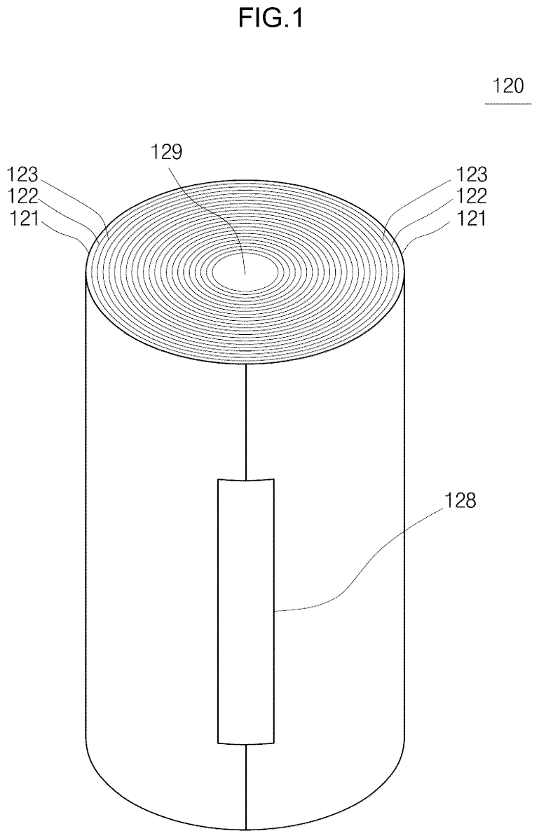

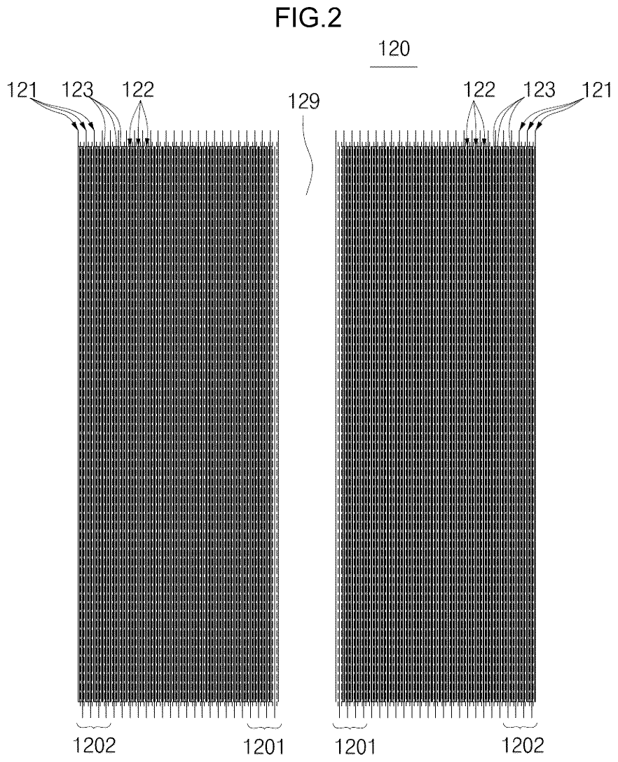

FIGS. 1 and 2 are a perspective view and a longitudinal cross-sectional view of an electrode assembly 120 according to embodiments of the present disclosure.

As illustrated in FIGS. 1 and 2, the electrode assembly 120 according to embodiments may be provided by being wound in a generally cylindrical shape. In some embodiments, the electrode assembly 120 may include a first electrode plate 121 (e.g., a negative electrode plate) coated with a first active material (e.g., a negative electrode active material including, e.g., graphite, carbon, etc.), a second electrode plate 122 (e.g., a positive electrode plate) coated with a second active material (e.g., a positive electrode active material including a transition metal oxide (e.g., LiCoO₂, LiNiO₂, and/or LiMn₂O₄), etc.), and a separator 123 disposed between the first electrode plate 121 and the second electrode plate 122 to prevent short circuit and allow only movement of lithium ions. In some embodiments, the first electrode plate 121, the separator 123, and the second electrode plate 122 may be wound in a cylindrical shape while being stacked as described above. In some embodiments, the first electrode plate 121 may include copper (Cu) or nickel (Ni) foil (e.g., a first current collector or a first base material), the second electrode plate 122 may include aluminum (Al) foil (e.g., a second current collector or a second base material), and the separator 123 may include polyethylene (PE) or polypropylene (PP).

In some embodiments, the outermost portion of the electrode assembly 120 may be finished with a sealing tape 128 so as not to be unwound after a winding process of the electrode assembly 120. In some embodiments, the electrode assembly 120 may include a core 129 provided at a center thereof as a hollow space. In some embodiments, the first base material may be exposed and/or protruded upward form the electrode assembly 120, and the second base material may be exposed and/or protruded downward from the electrode assembly 120, and vice versa. In some embodiments, any one of the first base material, the second base material, and the separator may be wound around the outermost portion of the electrode assembly 120. The electrode assembly 120 may include or be referred to as an electrode group, an electrode body, or a jelly roll.

The electrode assembly 120 may include a winding front end area 1201 and a winding rear end area 1202. In some embodiments, the winding front end area 1201 may mean an area on which the winding begins while the first electrode plate 121, the separator 123, and the second electrode plate 122 are stacked, e.g., the winding front end area 1201 may be an inner portion of the wound electrode assembly that is adjacent to and faces the core 129 of the electrode assembly 120. In some embodiments, the winding rear end area 1202 may mean an area on which the winding is ended while the first electrode plate 121, the separator 123, and the second electrode plate 122 are stacked, e.g., the winding rear end area 1202 may be opposite the winding front end area 1201 at an outer portion of the wound electrode assembly that is adjacent to an exterior of the electrode assembly 120.

In some embodiments, the winding front end area 1201 may mean an area of about 1 turn to about 5 turns in a direction from a winding front end at which the winding begins toward a winding rear end at which the winding is ended. In some embodiments, the winding rear end area 1202 may mean an area of about 1 turn to about 5 turns in a direction from the winding rear end at which the winding is ended toward the winding front end at which the winding begins.

Each of the first electrode plate 121, the separator 123, and the second electrode plate 122 of the electrode assembly 120 may include a preset winding interval. In some embodiments, a winding interval in the winding front end area 1201 may be different from a winding interval in the winding rear end area 1202. In some embodiments, the winding interval in the winding front end area 1201 may be greater than the winding interval in the winding rear end area 1202 (e.g., a winding trailing end area).

In some embodiments, the above-described winding interval may include a winding interval of the first electrode plate 121 or the second electrode plate 122. For example, the winding interval may mean a winding interval of the first electrode plate 121 or a winding interval of the second electrode plate 122. The winding interval may include or be referred to as a pitch, a spacing, a gap, or a crack.

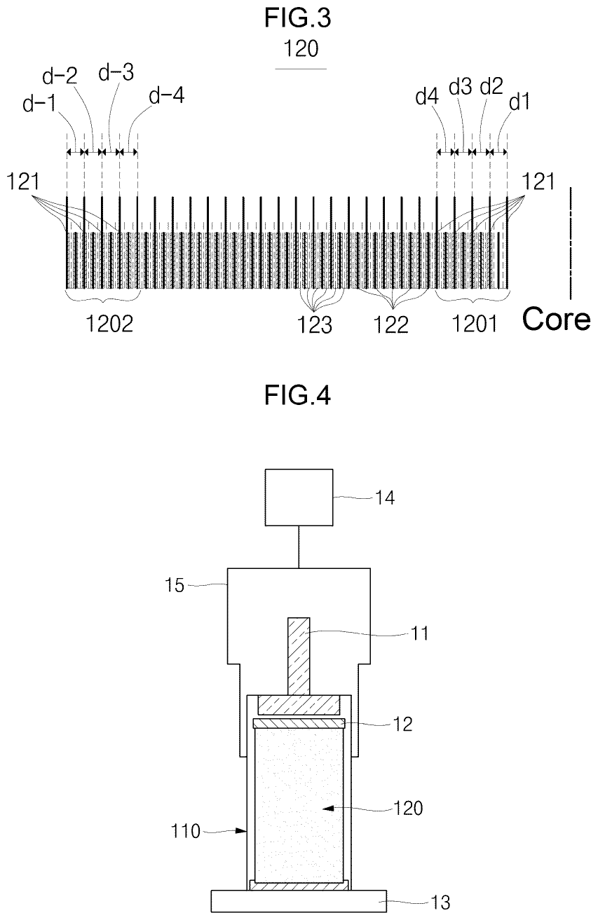

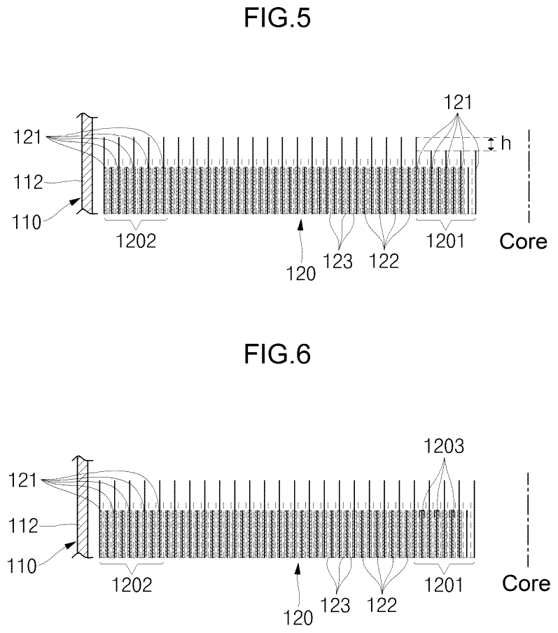

FIG. 3 is a cross-sectional view illustrating a portion of the electrode assembly 120 in the secondary battery according to embodiments of the present disclosure. In FIG. 3, the electrode assembly 120 may be accommodated in a case 110, and the case 110 will be described in detail below with reference to FIG. 4. Here, descriptions will be made with reference to FIGS. 2 and 3 together.

Referring to FIGS. 2 and 3, in some embodiments, the first electrode plate 121 may protrude farther upward than (e.g., beyond) the second electrode plate 122. In some embodiments, the second electrode plate 122 may protrude farther downward than (e.g., beyond) the first electrode plate 121.

In some embodiments, the second electrode plate 122 may protrude farther upward than the first electrode plate 121. In some embodiments, the first electrode plate 121 may protrude farther downward than the second electrode plate 122.

In some embodiments, in the direction oriented from the winding front end area 1201 to the winding rear end area 1202 (e.g., in a radial direction of the electrode assembly 120 oriented from the center toward an outer edge of the electrode assembly 120), a winding interval between one (1) turn and two (2) turns may be defined as d1, a winding interval between two (2) turns and three (3) turns may be defined as d2, a winding interval between three (3) turns and four (4) turns may be defined as d3, and a winding interval between four (4) turns and five (5) turns may be defined as d4. In some embodiments, in the direction from the winding rear end area 1202 to the winding front end area 1201 (e.g., in a radial direction of the electrode assembly 120 oriented from the outer edge toward the center of the electrode assembly 120), a winding interval between one (1) turn and two (2) turns may be defined as d-1, a winding interval between two (2) turns and three (3) turns may be defined as d-2, a winding interval between three (3) turns and four (4) turns may be defined as d-3, and a winding interval between four (4) turns and five (5) turns may be defined as d-4.

In the electrode assembly 120 according to embodiments, a ratio of the winding intervals may satisfy the following equation: (d2+d3+d4)/(d-2+d-3+d-4)>1.

Here, the reason why the d1 and d-1 are not used in the above mathematical equation is that there are cases in which the innermost current collector or the outermost current collector is not coated with an electrically active material, and if the current collector is not coated with the electrically active material in this manner, a large deviation occurs in the interval between the electrode plates. Thus, the values of the d1 and d-1 are not used in the above mathematical equation. In some embodiments, the winding interval may mean an interval between the current collectors (e.g., the negative current collector or the positive current collector).

As described above, the electrode assembly 120 according to the present disclosure may include a winding interval of the winding front end area 1201, i.e., an inner circumference, being greater than the winding interval of the winding rear end area 1202, i.e., an outer circumference. In some embodiments, the winding interval in the winding front end area 1201 may be from about 340 μm to about 370 μm, and the winding interval in the winding rear end area 1202 may be from about 320 μm to about 339 μm.

In some embodiments, a height at the winding front end area 1201 may increase by about 0.5 mm to about 2 mm after the charge/discharge cycle of the secondary battery (or electrode assembly). In some embodiments, a perfect circle ratio in the winding front end area 1201 (e.g., core) after the charge/discharge cycle of the secondary battery (or electrode assembly) may be from about 95% to about 99%.

Here, “after the charge/discharge cycle has been performed” means, e.g., after about 500 cycles have been performed. In some embodiments, as an example, charge conditions may be CCCV: 4.2 V, and 0.5 C, and charge cut conditions may be about 0.05 C. In some embodiments, as an example, the discharge conditions may be CC 0.5 C, and the discharge cut conditions may be 2.5V. In some embodiments, the charge/discharge cycle may be performed at approximately 45° C.

A method for manufacturing a secondary battery having the electrode assembly 120 may include a process of preparing the electrode assembly 120, a process of accommodating the electrode assembly 120 in the case 110 (FIG. 4), a process of fixing the electrode assembly 120, and a process of pressing the electrode assembly 120.

In the process of preparing the electrode assembly 120, the electrode assembly 120 in which the first electrode plate 121, the separator 123, and the second electrode plate 122 are stacked and wound into a cylindrical shape may be prepared. In some embodiments, the electrode assembly 120 may include the winding front end area 1201 and the winding rear end area 1202. In the process of accommodating the electrode assembly 120 in the case 110, the electrode assembly 120 may be accommodated in the case 110 (e.g., a cylindrical case). In the process of fixing the electrode assembly 120, a pusher 11 (FIG. 4) may be inserted into the case 110 to fix an upper end of the electrode assembly 120. In some embodiments, an insulating plate 12 may be further interposed between the pusher 11 and the electrode assembly 120. In the process of pressing the electrode assembly 120, the upper end of the electrode assembly 120 may be pressed by the pusher 11. Because the electrode assembly 120 is pressed by the pusher 11 as described above, the winding interval in the winding front end area 1201 may be different from the winding interval in the winding rear end area 1202. For example, the winding interval in the winding front end area 1201 may be greater than the winding interval in the winding rear end area 1202. In some embodiments, a pressure provided in the pressing process may be from about 0.1 MPa to about 1 MPa. In some embodiments, the number of times of the pressing provided in the pressing process may be from about 3 to about 10.

FIG. 4 is a schematic view illustrating the method for pressing the electrode assembly 120 in the secondary battery according to embodiments of the present disclosure.

As illustrated in FIG. 4, the case 110 to which the electrode assembly 120 is coupled may be disposed on a substantially flat stage 13. For example, the pusher 11 that is capable of being elevated in a vertical direction (e.g., movable in an upward and downward direction relative to the case 110) by a solenoid 14 may be coupled to the case 110 to press the electrode assembly 120. In some embodiments, an upper fixing jig 15 may be coupled to an upper end of the case 110 to prevent the case 110 from moving in the vertical and horizontal directions, and the pusher 11 may pass through the upper fixing jig 15 to press the electrode assembly 120. In some embodiments, the pusher 11 may include a high strength resin, e.g., Unilate™. The pusher 11 may repeatedly perform the pressing, e.g., about 3 times to about 10 times, at a pressure of about 0.1 MPa to about 1 MPa as described above while fixing the upper portion of the electrode assembly 120. Here, Unilate™ is high-functional engineering plastic made by heating and stacking glass fiber, inorganic filler, etc. using polyethylene terephthalate (PET) as a main raw material after charging complex extrusion molding.

In some embodiments, in the present disclosure, a pressure may be applied to the electrode assembly 120 before injecting an electrolyte and after the electrode assembly 120 is inserted into the case 110 (e.g., into the outer case). In some embodiments, after the electrode assembly 120 is inserted into the case 110, the electrode assembly 120 may be pressed, and thus, an outer circumferential portion of the electrode assembly 120 may be expanded so that an outer surface of the electrode assembly 120 is in contact with an inner surface of the case 110. In some embodiments, the interval between the electrode plates in the winding rear end area of the electrode assembly 120, i.e., the outer circumferential portion, may be widened. After the inner surface of the case 110 and the outer surface of the electrode assembly 120 are in contact with each other, the pressing by the pusher 11 may be repeated, and thus, the winding front end area of the electrode assembly 120, i.e., the inner circumferential portion, may receive force that is relaxed in the inward direction. In this manner, a relationship (d2+d3+d4)/(d-2+d-3+d-4)>1 described above may be established.

In some embodiments, in order to press the electrode assembly 120 in the winding direction as described above, the electrode assembly 120 may be pressed while being fixed by the pusher 11. In some embodiments, the pressing force and the number of times of the pressing by the pusher 11 may be important. As described above, the pressing force may be about 0.1 MPa to about 1 MPa, and the number of times of the pressing may be about 3 to about 10.

In case of an excessive pressure or excessive number of times, friction between the electrode plate and the separator may increase to cause deterioration in voltage failure. In addition, if the pressing force is too small or the number of times of the pressings is low, the interval between the electrode plates at the inner circumferential portion does may not be widened to make it difficult to expect the technical advantages of the present disclosure described above.

Table 1 below shows experimental results according to Embodiment 1, Embodiment 2, and Comparative Example.

TABLE 1

| | Pressure | | Winding front end area (μm) | | | | Winding rear end area (μm) | | | | | |
|---|---|---|---|---|---|---|---|---|---|---|---|---|
| | condition | #1 | d2 | d3 | d4 | Average | d-2 | d-3 | d-4 | Average | #2 | #3 |
| Embodiment | 0.5 Mpa | 1.05 | 348 | 348 | 347 | 348 | 332 | 332 | 332 | 332 | 1.5 | 97 |
| 1 | *7times | | | | | | | | | | | |
| Embodiment | 0.5 Mpa | 1.10 | 360 | 359 | 359 | 359 | 328 | 328 | 328 | 328 | 0.9 | 97 |
| 2 | *10times | | | | | | | | | | | |
| Comparative | — | 1 | 318 | 318 | 318 | 318 | 318 | 318 | 318 | 318 | 2.0 | 65 |
| Example | | | | | | | | | | | | |

#1: Interval ratio between inner/outer electrode plates (d2+d3+d4)/(d-2+d-3+d-4)
#2: Increase in height of inner negative electrode (mm) (after cycle—initial)
#3: Perfect circle ratio (%) of center core of electrode assembly 120 after cycle

In some embodiments, the winding front end area 1201 may be simply referred to as the inner circumferential portion, and the winding rear end area 1202 may be simply referred to as the outer circumferential portion.

Although the above-described method has been described in the present disclosure to implement the main features of the electrode assembly, various methods other than the above-described method may be possible.

FIG. 5 is a cross-sectional view illustrating a portion of the electrode assembly 120 in the secondary battery according to embodiments of the present disclosure. The electrode assembly 120 illustrated in FIG. 5 may share the features of the electrode assembly 120 illustrated in FIG. 4, and additionally, the height of the winding front end area 1201 may be less than the height of the winding rear end area 1202, e.g., relative to a bottom of the case 110. In some embodiments, the height of the winding front end area 1201 may be less by a height h than the height of the winding rear end area 1202. In some embodiments, the height h may be about 0.5 mm to about 2 mm. In general, after the charge/discharge cycle of the secondary battery is performed, the height of the winding front end area 1201 may increase by about 0.5 mm to about 2 mm. If considering this height, the height of the winding front end area 1201 may be reduced in advance by about 0.5 mm to about 2 mm. In some embodiments, even after the charge/discharge cycle of the secondary battery, a protruding height of the winding front end area 1201 may be equal to or less than a protruding height of the winding rear end area 1202, and thus, core deformation and/or short circuit of the electrode assembly 120 may be prevented.

FIG. 6 is a cross-sectional view illustrating a portion of the electrode assembly 120 in the secondary battery according to embodiments of the present disclosure. The electrode assembly 120 illustrated in FIG. 6 may share the features of the electrode assembly 120 illustrated in FIG. 3 and/or FIG. 5, and additionally, the electrode assembly 120 may include an insulating tape 1203 attached to an end of the winding front end area 1201 of the second electrode plate 122. In some embodiments, the features of the first electrode plate 121 may be shared as described above, and additionally, the insulating tape 1203 may be attached to the end of the winding front end area 1201 of the second electrode plate 122 to prevent a short circuit between the first electrode plate 121 and the second electrode plate 122 form occurring at the winding front end area 1201 even after the charge/discharge cycle of the secondary battery.

Hereinafter, a configurations of several types of cylindrical secondary batteries including the above-described electrode assembly 120 have been briefly described. However, the electrode assembly 120 described above may also be applied to a cylindrical secondary battery that has not yet been disclosed.

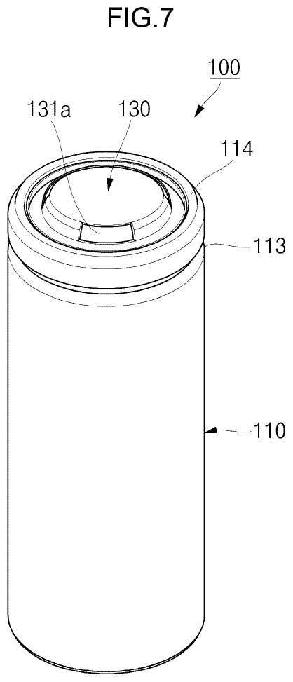

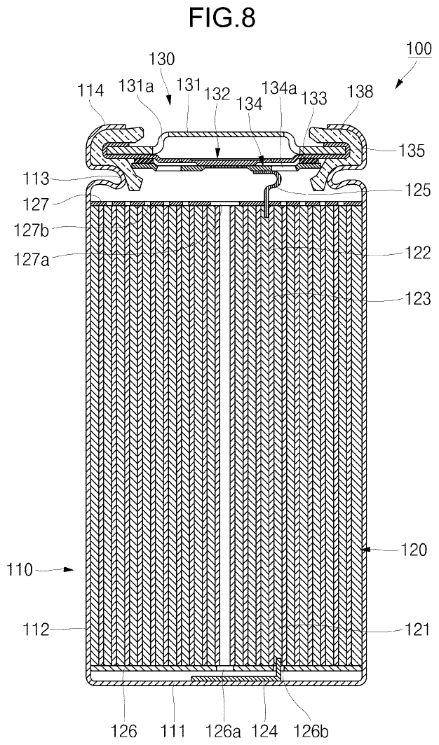

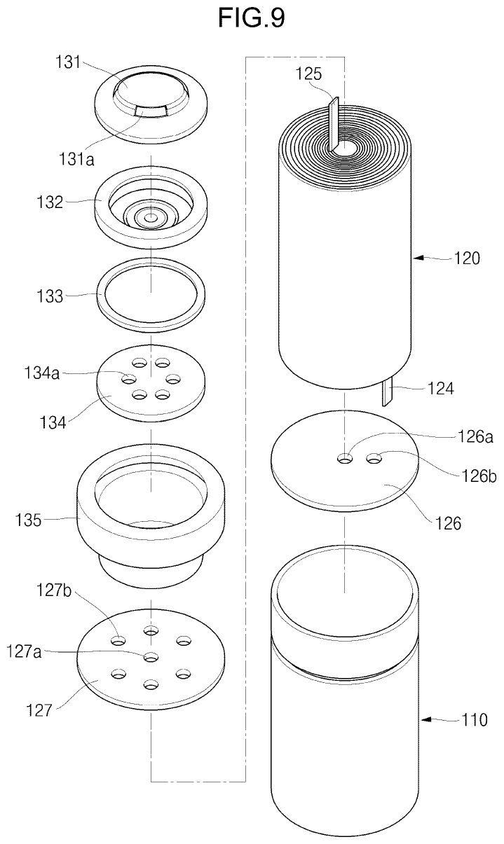

FIG. 7 is a perspective view of a secondary battery 100 according to embodiments of the present disclosure, FIG. 8 is a longitudinal cross-sectional view of FIG. 7, and FIG. 9 is an exploded perspective view of FIG. 7. As illustrated in FIGS. 7 to 9, the secondary battery 100 according to embodiments may include the case 110, the electrode assembly 120, and a cap assembly 130.

Referring to FIGS. 7-8, the case 110 may include a circular bottom part 111 (which may be referred to as a ceiling in some cases) and a cylindrical sidewall 112 extending upward from the bottom part 111 to a certain length. During a process of manufacturing the secondary battery, an upper portion of the case 110 may be opened. Thus, during a process of assembling the secondary battery, the electrode assembly 120 may be inserted into the case 110 (e.g., a cylindrical case) together with an electrolyte. In some embodiments, the case 110 may include steel, a steel alloy, nickel-plated steel, stainless steel, aluminum, or an aluminum alloy. In some embodiments, the case 110 may include or be referred to as a can, a housing, or an outer exterior. In some embodiments, the case 110 may include a beading part 113 recessed inward at a lower portion thereof with respect to the cap assembly 130 to prevent the electrode assembly 120 and the cap assembly 130 from being separated to the outside and may include a crimping part 114 bent inward at an upper portion thereof.

The electrode assembly 120 may be accommodated inside the case 110. The electrode assembly 120 may include the first electrode plate 121 (e.g., a negative electrode plate) coated with a negative electrode active material (e.g., graphite, carbon, etc.), the second electrode plate 122 (e.g., a positive electrode plate) coated with a positive electrode active material (e.g., transition metal oxide (e.g., LiCoO₂, LiNiO₂, LiMn₂O₄, etc.)), and the separator 123 disposed between the first electrode plate 121 and the second electrode plate 122 to prevent short circuit and allow only movement of lithium ions. In some embodiments, the first electrode plate 121, the second electrode plate 122, and the separator 123 may be wound in a roughly cylindrical shape. In some embodiments, the first electrode plate 121 may include copper (Cu) or nickel (Ni) foil, the second electrode plate 122 may include aluminum (Al) foil, and the separator 123 may include polyethylene (PE) or polypropylene (PP). In some embodiments, a negative electrode tab 124 that protrudes downward and extends by a certain length may be welded to the first electrode plate 121, and a positive electrode tab 125 that protrudes upward by a certain length may be welded to the second electrode plate 122, and vice versa. In some embodiments, the negative electrode tab 124 may include a copper or nickel material, and the positive electrode tab 125 may include an aluminum material. In some embodiments, the electrode assembly 120 may include or be referred to as an electrode group, an electrode body, or a jelly roll. In the description below, in some cases, the drawing symbols for the first electrode plate 121 and/or the second electrode plate 122 may be designated in reverse.

The electrode assembly 120 may include a winding front end area and a winding rear end area as described above, and a winding interval in the winding front end area may be different from a winding interval in the winding rear end area. For example, the winding interval in the winding front end area may be greater than the winding interval in the winding rear end area.

In some embodiments, the negative electrode tab 124 of the electrode assembly 120 may be welded to the bottom part 111 of the case 110. Thus, the case 110 may operate as a negative electrode. In some embodiments, the positive electrode tab 125 may be welded to the bottom part 111 of the case 110, and in this case, the case 110 may operate as a positive electrode.

In some embodiments, a first insulating plate 126 coupled to the case 110 and having a first hole 126a defined in a center thereof and a second hole 126b defined at the outside thereof may be interposed between the electrode assembly 120 and the bottom part 111. This first insulating plate 126 may prevent the electrode assembly 120 from being in electrical contact with the bottom part 111 of the case 110. In some embodiments, the first insulating plate 126 may prevent the second electrode plate 122 of the electrode assembly 120 from being in electrical contact with the bottom part 111. In some embodiments, the first hole 126a may allow a gas to move quickly upward if a large amount of gas is generated due to abnormality in the secondary battery, and the second hole 126b may allow the negative electrode tab 124 to pass through and be welded to the bottom part 111.

In some embodiments, a second insulating plate 127 coupled to the case 110 and having a first hole 127a defined in a center thereof and a plurality of second holes 127b defined at the outside thereof may be interposed between the electrode assembly 120 and the cap assembly 130. The second insulating plate 127 may prevent the electrode assembly 120 from being in electrical contact with the cap assembly 130. In some embodiments, the second insulating plate 127 may prevent the first electrode plate 121 of the electrode assembly 120 from being in electrical contact with the cap assembly 130. In some embodiments, the first hole 127a may allow a gas to quickly move to the cap assembly 130 if a large amount of gas is generated due to abnormality in the secondary battery, and the second hole 127b may allow the positive electrode tab 125 to pass through and be welded to the cap assembly 130. In some embodiments, the remaining second hole 127b may allow the electrolyte to quickly flow into the electrode assembly 120 during the electrolyte injection process.

Referring to FIGS. 8-9, the cap assembly 130 may include a cap-up 131 having a plurality of through-holes 131a, a safety vent 132 disposed at a lower portion of the cap-up 131, a connection ring 133 disposed at a lower portion of the safety vent 132, and a cap-down 134 disposed at a lower portion of each of the safety vent 132 and the connection ring 133, having a plurality of through-holes 134a, and electrically connected to the positive electrode tab 125. In some embodiments, the cap assembly 130 may further include an insulating gasket 135 that insulates the cap up 131, the safety vent 132, and the cap down 134 from the sidewall 112 of the case 110. In some embodiments, the cap assembly 130 may include or be referred to as a cap, a cap group, a cap assembly, a top, a cover, or a lid.

In some embodiments, the insulating gasket 135 may be compressed between the beading part 113 and the crimping part 114 disposed on the sidewall 112 of the substantially case 110. In some embodiments, the through-hole 131a of the cap up 131 and the through-hole 134a of the cap down 134 may discharge an internal gas to the outside if an abnormal internal pressure occurs inside the case 110. In some embodiments, the internal gas may invert the safety vent 132 upward through the through-hole 134a of the cap-down 134 so that the safety vent 132 is electrically isolated from the cap-down 134, and then the safety vent 132 is torn to discharge the internal gas to the outside through the through-hole 131a of the cap-up 131.

In some embodiments, an electrolyte may be injected into the inside of the case 110 to allow lithium ions generated by an electrochemical reaction on the first electrode plate 121 and the second electrode plate 122 inside the battery to move during the charging and discharging. The electrolyte may include a non-aqueous organic electrolyte that is a mixture of lithium salt and a high-purity organic solvent. In some embodiments, the electrolyte may include a polymer or solid electrolyte using a polymer electrolyte.

Meanwhile, as the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D′_{c} (0.90≤a≤1.8, 0≤b≥0.5, 0≤c≤0.05); LiₐMn_{2-b}X_{b}O_{4-c}D′_{c} (0.90≤a≤1.8, 0≤b≥0.5, 0≤c≤0.05); LiₐNi_{1-b-c}Co_{b}X_{c}O_{2-α}D′_{α} (0.90≤a≤1.8, 0≤b≤0.5, 0≤c≤0.5, 0<α<2); LiₐNi_{1-b-c}Mn_{b}X_{c}O_{2-α}D′_{α} (0.90≤a≤1.8, 0≤b≤0.5, 0≤c≤0.5, 0<α<2); LiₐNi_{b}Co_{c}L1_{d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≥0.1); LiₐMn_{1-b}G_{b}O₂ (0.90≤a≤1.8, 0.001≤b≥0.1); LiₐMn₂G_{b}O₄ (0.90≤a≤1.8, 0.001≤b≥0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D′ is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x≤2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

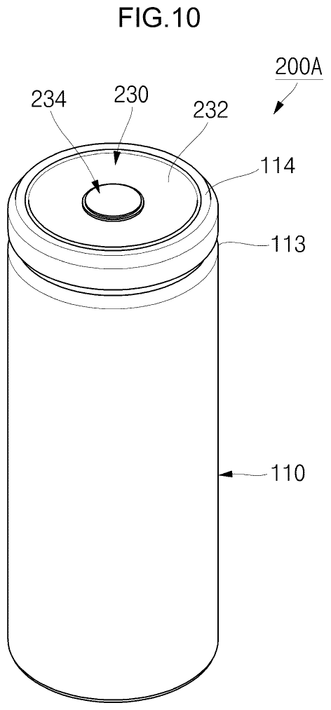

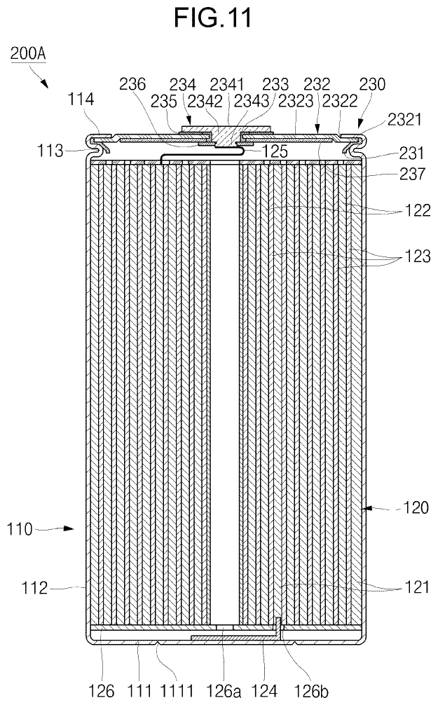

FIG. 10 is a perspective view of a secondary battery according to embodiments of the present disclosure, and FIG. 11 is a longitudinal cross-sectional view of FIG. 10. As illustrated in FIGS. 10 and 11, a secondary battery 200A according to another embodiment may include the case 110, the electrode assembly 120, and a cap assembly 230.

Here, the case 110 and the electrode assembly 120 are identical or similar to those described above, so their descriptions will be omitted. However, to prevent the cap assembly 230 from being separated to the outside, a beading part 113 that is recessed inward at a lower portion with respect to the cap assembly 230 may be provided in the case 110, and a crimping part 114 that is bent inward may be provided at an upper portion thereof. In some embodiments, a safety vent 1111 may be provided at the bottom part 111 of the case 110. In some embodiments, the safety vent 1111 may be provided in a generally circular ring shape or C shape. In some embodiments, the safety vent 1111 may include or be referred to as a notch, a recess, or a groove.

The cap assembly 230 may include a first insulating gasket 231, a cap plate 232, a second insulating gasket 233, and a rivet terminal 234. In some embodiments, the cap assembly 230 may further include an upper insulator 235, a lower insulator 236, and an inner insulator 237.

The first insulating gasket 231 may be interposed between the beading part 113 and the crimping part 114 provided in the case 110. In some embodiments, an upper end of the first insulating gasket 231 may be disposed between the beading part 113 and the crimping part 114, and a lower end of the first insulating gasket 231 may be disposed inside the beading part 113. In some embodiments, the first insulating gasket 231 may include an insulator that does not react with the electrolyte. In some embodiments, the first insulating gasket 231 may include polypropylene (PP), polyethylene (PE), ethylene propylene diene monomer (EPDM), or nitrile butadiene rubber (NBR). The first insulating gasket 231 may isolates the inside and outside of the case 110 from each other to prevent the electrolyte inside the can from leaking to the outside or external foreign substances (e.g., moisture or dust) from being introduced into the can.

The cap plate 232 may be fixed by being coupled between the beading part 113 and the crimping part 114 through the first insulating gasket 231. In some embodiments, the cap plate 232 may include a cap plate circumferential area 2321, a cap plate inclined area 2322, and a cap plate central area 2323. The cap plate central area 2323 may include a terminal hole 2324 through which the second insulating gasket 233 and the rivet terminal 234 pass to be coupled. In some embodiments, the cap plate 232 may include aluminum, copper, nickel, iron, or an alloy thereof. In some embodiments, the cap plate 232 may include or be referred to as a cap, a cap-up, a plate, a top, a lid, or a cover.

The cap plate circumferential area 2321 may be coupled between the beading part 113 and the crimping part 114. In some embodiments, a side surface and an inner surface (bottom surface) of the cap plate circumferential area 2321 may be in close contact with the first insulating gasket 231, and an outer surface (top surface) of the cap plate circumferential area 2321 may be in close contact with the crimping part 114. In some embodiments, the outer surface of the cap plate circumferential area 2321 may be electrically connected to the inner surface of the crimping part 114. Thus, the case 110 and the cap plate may have the same polarity.

The cap plate inclined area 2322 may extend from the cap plate circumferential area 2321 and then be inclined upward. The cap plate inclined area 2322 may connect the cap plate circumferential area 2321 to the cap plate central area 2323 to each other.

The cap plate central area 2323 may extend from the cap plate inclined area 2322. The cap plate central area 2323 may include an approximately flat outer surface (top surface) and an approximately flat inner surface (bottom surface) opposite the outer surface. The terminal hole 2324 may pass through the cap plate central area 2323. In some embodiments, the outer surface of the crimping part 114 and the outer surface of the cap plate central area 2323 may be substantially in the same plane.

The second insulating gasket 233 may be coupled to the terminal hole 2324. In some embodiments, the second insulating gasket 233 may cover an inner wall of the terminal hole 2324, a portion of the outer surface of the cap plate central area 2323, and a portion of the inner surface of the cap plate central area 2323. A material of the second insulating gasket 233 may be similar to that of the first insulating gasket 231. The second insulating gasket 233 may include or be referred to as a sealing gasket or a sealing insulator.

The rivet terminal 234 may be coupled by passing through the second insulating gasket 233. In some embodiments, the rivet terminal 234 may be coupled by passing through the terminal hole 2324 of the cap plate 232.

In some embodiments, the rivet terminal 234 may include a rivet head 2341 disposed on an outer surface of the cap plate 232, a rivet body 2342 disposed on an inner surface of the terminal hole 2324, and a rivet leg 2343 disposed on an inner surface of the cap plate 232. In some embodiments, the rivet head 2341, the rivet body 2342 and the rivet leg 2343 may be provided to be integrated with each other and may have a cross-sectional shape that is approximately “T” shaped. In some embodiments, the rivet terminal 234 may include aluminum, copper, nickel, iron or an alloy thereof.

As described above, the positive electrode tab 125 may be electrically connected to the rivet leg 2343 of the rivet terminal 234. In some embodiments, the positive electrode tab 125 may be welded to the rivet leg 2343. In some embodiments, the rivet terminal 234 may have bipolar characteristics. In some embodiments, the cap plate 232 may serve as the negative electrode terminal, and the rivet terminal 234 may serve as the positive electrode terminal. In some embodiments, because the cap plate 232 is electrically connected to the crimping part 114 of the case 110, the cap plate 232 may have negative electrode characteristics, and because the rivet terminal 234 is electrically connected to the positive electrode tab 125, the rivet terminal 234 may have positive electrode characteristic. Thus, in the present disclosure, the two terminals (the positive electrode terminal and the negative electrode terminal) may be provided simultaneously on an upper area of the cylindrical secondary battery 200A.

The upper insulator 235 may be provided between the rivet terminal 234 and the cap plate 232. In some embodiments, the upper insulator 235 may be interposed between the rivet head 2341 and the cap plate central area 2323.

The lower insulator 236 may be interposed between the rivet body 2342 and/or the rivet leg 2343 and the cap plate central area 2323. In some embodiments, the lower insulator 236 may be interposed between the rivet leg 2343 and the second insulating gasket 233 and/or the inner insulator 237.

The inner insulator 237 may additionally be provided on an inner surface of the cap plate 232. In some embodiments, the inner insulator 237 may be provided on the cap plate central area 2323. In some embodiments, the inner insulator 237 may be provided on an inner surface of the cap plate central area 2323. In some embodiments, the inner insulator 237 may be provided from the terminal hole 2324 provided on the cap plate central area 2323 to the cap plate inclined area 2322.

In some embodiments, each of the insulator 235, 236, and 237 may include an insulator that does not react with the electrolyte. In some embodiments, each of the insulator 235, 236, and 237 may include PP, PE, EPDM or NBR. In some embodiments, each of the insulator 235, 236, and 237 may be provided by being applied on the cap plate 232 in a liquid state and then cured, or each of the insulator 235, 236, and 237 may be provided separately and then assembled onto the cap plate 232.

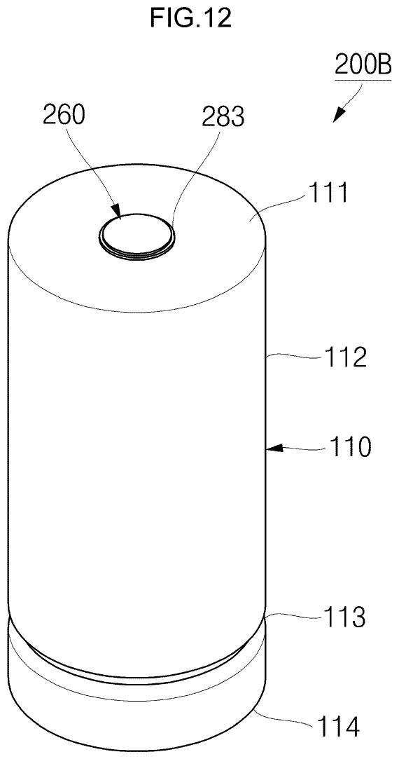

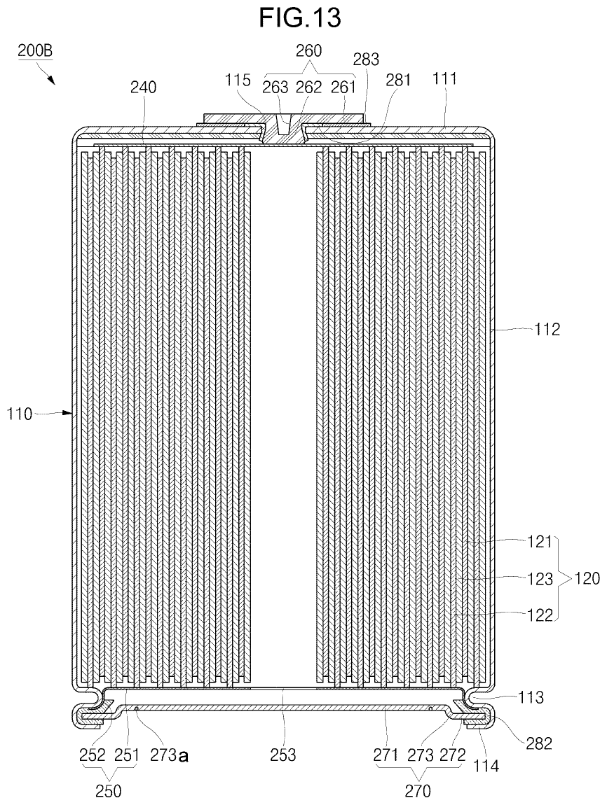

FIG. 12 is a perspective view of a secondary battery 200B according to further other embodiments, and FIG. 13 is a longitudinal cross-sectional view of FIG. 12. As illustrated in FIGS. 12 and 13, the secondary battery 200B according to another embodiment may include the case 110, the electrode assembly 120, a positive electrode current collector plate 240, a negative electrode current collector plate 250, a rivet terminal 260, and a cap plate 270.

The case 110 may include a circular ceiling 111 (which may be referred to as a bottom part in some cases) and the sidewall 112 extending downward from an edge of the ceiling 111 to a certain length. The ceiling 111 and the sidewall 112 of the case 110 may be provided to be integrated with each other.

The ceiling 111 may have a flat circular plate shape and may be provided with a terminal hole 115 passing through a central portion thereof. The ceiling 111 may be coupled by inserting the rivet terminal 260 into the terminal hole 115. A first gasket 281 for sealing and electrical insulation may be further interposed between the terminal hole 115 and the rivet terminal 260. The first gasket 281 may be inserted into the terminal hole 115 to extend to an upper side of the ceiling 111. The first gasket 281 may prevent contact between the rivet terminal 260 and the case 110 to electrically separating the rivet terminal 260 and the case 110 from each other. The terminal hole 115 of the ceiling 111 of the case 110 may be sealed by the first gasket 281. The first gasket 281 may be made of a resin material such as polyethylene (PE), polypropylene (PP), polyethylene terephthalate (PET), etc.

An upper portion of the case 110 of the cylindrical secondary battery 200B may be opened during the manufacturing process. Thus, during the manufacturing process of the cylindrical secondary battery 200B, the electrode assembly 120 may be inserted through the opened upper portion of the case 110. In this case 110, after the electrode assembly 120 is inserted, and the electrolyte is injected, the cap plate 270 may be coupled to the opened upper portion to seal the case 110. In some embodiments, if the case 110 is turned over, the ceiling 111 may be disposed at a lower portion of the case 110, and the cap plate 270 may be coupled to an upper end of the case 110.

The electrode assembly 120 may include the first electrode plate 121, the second electrode plate 122, and the separator 123. The electrode assembly 120 may be wound into an approximately cylindrical shape by being wound from a winding front end after the first electrode plate 121, the second electrode plate 122, and the separator 123 are stacked. In addition, in the electrode assembly 120, a negative electrode non-coating portion that is not coated with a negative active material may protrude upward from the first electrode plate 121, and a positive electrode non-coating portion that is not coated with a positive active material may protrude downward from the second electrode plate 122, and vice versa.

This electrode assembly 120 may include a winding front end area and a winding rear end area as described above, and a winding interval in the winding front end area may be different from a winding interval in the winding rear end area. For example, the winding interval in the winding front end area may be greater than the winding interval in the winding rear end area.

The positive electrode current collector plate 240 may be a circular metal plate having a shape corresponding to that of a top surface of the electrode assembly 120. A surface area (or size) of the positive electrode current collector plate 240 may be equal to or less than that of the top surface of the electrode assembly 120. The positive electrode current collector plate 240 may be made of aluminum (Al). The positive electrode current collector plate 240 may be fixed and electrically connected to the second electrode plate 122 exposed to an upper side of the electrode assembly 120 by welding in a state in which a bottom surface thereof is in contact with the top surface of the electrode assembly 120. The positive electrode current collector plate 240 may be fixed and electrically connected to the rivet terminal 260 by welding in a state in which a top surface thereof in contact with a bottom surface of the rivet terminal 260. The positive electrode current collector plate 240 may serve as a passage for a current flow between the first electrode plate 121 of the electrode assembly 120 and the rivet terminal 260.

The negative electrode current collector plate 250 may include a circular flat part 251 corresponding to the bottom surface of the electrode assembly 120 and an extension part 252 extending upward from an edge of the flat part 251. A top surface of the flat part 251 may be in contact with the bottom surface of the electrode assembly 120. The top surface of the flat part 251 may be fixed and electrically connected to the second electrode plate 122 exposed to a lower side of the electrode assembly 120 by welding in a state in which the top surface of the flat part 251 is in contact with the bottom surface of the electrode assembly 120. In some embodiments, a through-hole 253 may be defined in the flat part 251. At least one through-hole 253 may be defined in the flat part 251. In some embodiments, the through-hole 253 may be a passage through which an electrolyte injected into the case 110 moves, or a passage through which an internal gas moves.

The extension part 252 may be bent from an edge of the flat part 251 to extend downward. The extension part 252 may be in contact with and coupled to the beading part 113 of the case 110. In some embodiments, the extension part 252 may be provided in a round shape to correspond to the beading part 113. For example, the extension part 252 may be coupled by welding in a state of being in contact with an inner surface of the beading part 113 of the case 110. In some embodiments, a second gasket 282 may be disposed below the extension part 252, and thus, the negative electrode current collector plate 250 may be electrically insulated from the cap plate 270. In some embodiments, the extension part 252 may be provided in plurality, which are spaced apart from each other along the edge of the flat part 251. The negative electrode current collector plate 250 may be a current flow passage between the second electrode plate 122 of the electrode assembly 120 and the case 110. That is, the case 110 may be a negative electrode terminal.

The rivet terminal 260 may be inserted into the terminal hole 115 provided in the ceiling 111 of the case 110 and electrically connected to the positive electrode current collector plate 240. That is, the rivet terminal 260 may be a positive electrode terminal. The rivet terminal 260 and the case 110 may have different polarities. The rivet terminal 260 may be made of the same or similar material as each of the positive electrode current collector plate 240 and the first electrode plate 121. In the rivet terminal 260, each of a diameter of a portion thereof, which is exposed to the upper side of the case 110, and a diameter thereof, which is disposed inside the case 110, may be greater than a diameter thereof, which is disposed in the terminal hole 115.

The rivet terminal 260 may include a head 261 exposed to the upper side of the case 110 and a coupling part 262 disposed inside the case 110 and coupled to the positive electrode current collector plate 240. The rivet terminal 260 may be coupled to the terminal hole 115 of the case 110 from the outside to the inside. In some embodiments, the head 261 may be disposed outside the case 110. In some embodiments, the coupling part 262 may be compressed to be deformed (compressed to be molded) by riveting and compressed in a state in which the first gasket 281 is interposed in s lower portion of the ceiling 111. Here, the coupling part 262 may have a larger diameter as it goes toward the inside of the case 110 from the terminal hole 115. In some embodiments, a diameter of a lower portion of the coupling part 262 may be greater than that of an upper portion of the coupling part 262. Here, the upper portion of the coupling part 262 may refer to a portion connected to the head 261. A diameter of a lower part of the coupling part 262 may be greater than a diameter of the terminal hole 115, and the diameter of the terminal hole 115 may be greater than a diameter of the upper portion of the coupling part 262. In some embodiments, the head 261 may be in close contact with the upper portion of the ceiling 111 in a state in which the first gasket 281 is interposed therein. In some embodiments, the first gasket 281 may be interposed between the rivet terminal 260 and the terminal hole 115. The rivet terminal 260 may be electrically connected to the first electrode plate 121 of the electrode assembly 120 through the positive electrode current collector plate 240.

In some embodiments, an insulating member 283 may be further interposed between the head 261 and the ceiling 111 of the case 110. In some embodiments, the head 261 may be disposed below the ceiling 111, and the insulating member 283 that prevents electrical contact between the rivet terminal 260 and the case 110 may be interposed in the area on which the head 261 and the ceiling 111 overlap each other on a plane. A diameter of the insulating member 283 may be greater than that of the head 261. In some embodiments, an outer circumference (or end) of the insulating member 283 may extend to be exposed to the outside of the head 261.

The first gasket 281 may be interposed between the coupling part 262 and the terminal hole 115 of the case 110, and an upper end of the first gasket 281 may extend between the head 261 and the ceiling 111 of the case 110. In some embodiments, a distal end of the upper end of the first gasket 281 may be in contact with the insulating member 283. That is, the first gasket 281 and the insulating member 283 may be interposed between the rivet terminal 260 and the ceiling 111 of the case 110, and thus, the rivet terminal 260 and the case 110 may be electrically insulated from and sealed to each other. In some embodiments, the first gasket 281 and the insulating member 283 may be provided to be integrated with each other.

The rivet terminal 260 may further include a welding groove 263 having a certain depth from a top surface of the head 261 toward the coupling part 262. That is, the welding groove 263 may be defined downward from a lower portion of the coupling part 262 through a central portion of the head 261. A thickness of the coupling part 262 may be reduced by the welding grooves 263, and thus, the welding of the coupling part 262 and the positive electrode current collector plate 240 at the outside of the case 110 may be facilitated.

The cap plate 270 may be provided as a circular metal plate that may be coupled to a lower end of the case 110. A bottom surface of the cap plate 270 may be exposed to the outside. The cap plate 270 may be coupled to the lower end of the case 110 in a state in which the second gasket 282 is interposed to be prevented from being electrically connected to the case 110. Because the cap plate 270 is not electrically connected to the positive or negative electrode of the electrode assembly 120, there may be no separate electrical polarity.

The cap plate 270 may include a first area 271 disposed on the negative electrode current collector plate 250, a second area 272 disposed outside the first area 271, and a third area 273 disposed between the first area 271 and the second area 272. The first area 271 may be disposed at a center of the cap plate 270 and may include a relatively large area. The second area 272 may be provided to protrude upward more than the first area 271. The second area 272 may be interposed between the beading part 113 and the crimping part 140 of the case 110 and may be coupled to the case 110. The third area 273 may be provided to be inclined or bent to connect the first area 271 to the second area 272, which have different heights. The second area 272 may be fixed in a state of being disposed between the beading part 113 and the crimping part 140 of the case 110. In some embodiments, in the state in which the second gasket 282 is interposed in the upper portion of the beading part 113 of the case 110, the second area 272 may be seated on an upper portion of the second gasket 282. Thereafter, the crimping part 140 of the case 110 may be bent inward from the cap plate 270 to press the second gasket 282, thereby coupling the cap plate 270 to the case 110. The second gasket 282 may be in close contact between the case 110 and the cap plate 270. In some embodiments, the second gasket 282 may be in close contact with the inside of the beading part 113 and the crimping part 140. An end of the second gasket 282 disposed between the cap plate 270 and the crimping part 140 may be provided to extend further into the case 110 than an end of the crimping part 140 and then be exposed to the outside. The end of the second gasket 282 disposed between the cap plate 270 and the beading part 113 may be provided to protrude further into the case 110 than the beading part 113. The second gasket 282 may be made of a resin material such as polyethylene (PE), polypropylene (PP), or polyethylene terephthalate (PET).

The above cap plate 270 may be disposed on the first area 271 and may include a vent 273a that may be opened at a set pressure. The vent 273a may be thinner than other areas of the cap plate 270. The vent 273a may be a notch provided upward from the bottom surface of the cap plate 270. The vent 273a may be provided in a portion of the first area 271, which is adjacent to the third area 273. In some embodiments, the vent 273a may be provided in a continuous notch shape and may be circular. In some embodiments, the vents 273a may be in the form of notches spaced apart from each other.

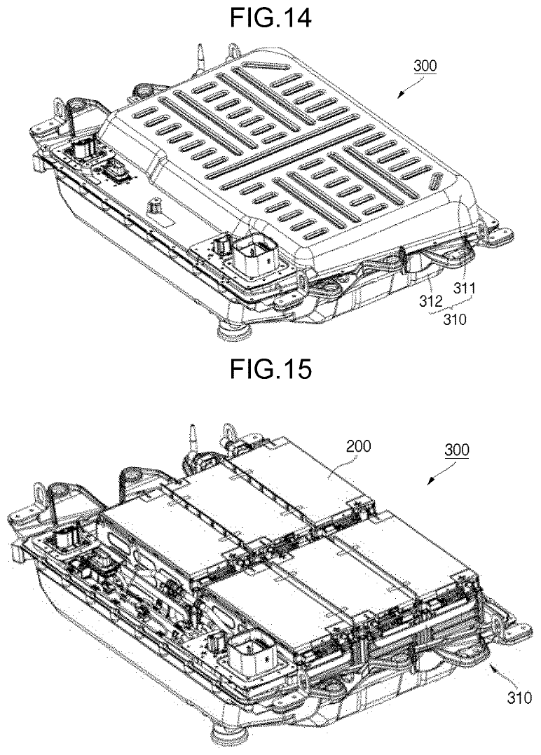

FIGS. 14 and 15 show a battery pack 300 according to one or more embodiments of the present disclosure. The battery pack 300 may include a plurality of battery modules 200 and a housing 310 for accommodating the plurality of battery modules 200. For example, the housing 310 may include first and second housings 311 and 312 coupled in opposite directions through the plurality of battery modules 200. The plurality of battery modules 200 may be electrically connected to each other by using a bus bar, and the plurality of battery modules 200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of battery cells are omitted. In one or more embodiments, battery pack 300 may be mounted in a vehicle. The vehicle may be, for example, an electric vehicle, a hybrid vehicle, or a plug-in hybrid vehicle. A vehicle may include a four-wheeled vehicle or a two-wheeled vehicle.

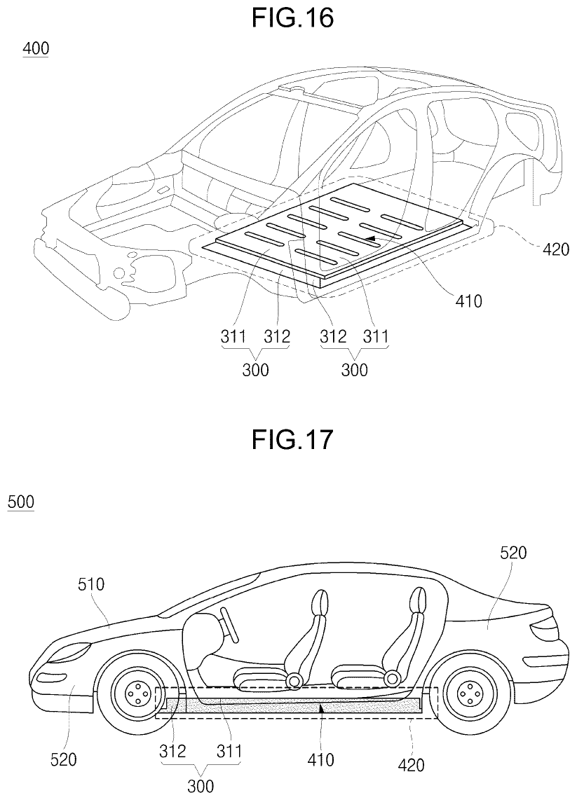

FIGS. 16 and 17 show vehicle body parts 400 and vehicle 500 according to one or more embodiments of the present disclosure including the battery pack 300 shown in FIGS. 14 and 15.

In FIG. 16, a battery pack 300 may include a battery pack cover 311, which is a part of a vehicle underbody 410 and may correspond to the first housing, and a pack frame 312, which is disposed under the vehicle underbody 410 and may corresponding to the second housing. The battery pack cover 311 and the pack frame 312 may be integrally formed with a vehicle floor 420. The vehicle underbody 410 separates the inside and outside of a vehicle, and the pack frame 312 may be disposed outside the vehicle.

In FIG. 17, a vehicle 500 may be formed by combining additional parts, such as a hood 510 in front of the vehicle 500 and fenders 520 respectively located in the front and rear of the vehicle 500 to a vehicle body pars 400. The vehicle 500 may include the battery pack 300 including the battery pack cover 311 and the pack frame 312, and the battery pack 300 may be coupled to the vehicle body part 400.

According to the present disclosure, the electrode assembly capable of suppressing the core deformation during the charging and discharging and the secondary battery having the same may be provided. For example, the present disclosure may provide the secondary battery, in which, in the electrode assembly of the cylindrical secondary battery, because the interval between the electrode plates on the winding front end area is greater than that between the electrode plates on the winding rear end area, the deformation and short-circuit of the electrode assembly are suppressed during the charging and discharging.

By way of summation and review, aspects of some embodiments of the present disclosure provide an electrode assembly capable of suppressing core deformation during charging and discharging, and a secondary battery having the same. Other aspects of some embodiments of the present disclosure provide a secondary battery, in which, in an electrode assembly of a cylindrical secondary battery, because an interval between electrode plates on a winding front end area is greater than that between electrode plates on a winding rear end area, deformation and short-circuit of an electrode assembly are suppressed during charging and discharging.

These and other aspects and features of the present disclosure were described in or will be apparent from the above description of embodiments of the present disclosure.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An electrode assembly, comprising:
a first electrode plate, a separator, and a second electrode plate in a wound structure, the wound structure having a cylindrical shape, wherein:
a winding front end area is at a beginning of the wound structure,
a winding rear end area is at an end of the wound structure, and
a winding interval in the winding front end area is different from a winding interval in the winding rear end area.

2. The electrode assembly as claimed in claim 1, wherein the winding interval in the winding front end area is greater than the winding interval in the winding rear end area.

3. The electrode assembly as claimed in claim 1, wherein:
the winding front end area comprises about 1 turn to about 5 turns in a direction oriented from the winding front end area toward the winding rear end area, and
the winding rear end area comprises about 1 turn to about 5 turns in a direction oriented from the winding rear end area toward the winding front end area.

4. The electrode assembly as claimed in claim 1, wherein the winding interval comprises a winding interval of the first electrode plate or a winding interval of the second electrode plate.

5. The electrode assembly as claimed in claim 1, wherein the first electrode plate protrudes farther in one direction than the second electrode plate.

6. The electrode assembly as claimed in claim 1, wherein:
in a direction oriented from a winding front end to a winding rear end, a winding interval between about 1 turn and about 2 turns is defined as d1, a winding interval between about 2 turns and about 3 turns is defined as d2, a winding interval between about 3 turns and about 4 turns is defined as d3, and a winding interval between about 4 turns and about 5 turns is defined as d4,
in a direction oriented from the winding rear end to the winding front end, a winding interval between about 1 turn and about 2 turns is defined as d-1, a winding interval between about 2 turns and about 3 turns is defined as d-2, a winding interval between about 3 turns and about 4 turns is defined as d-3, and a winding interval between about 4 turns and about 5 turns is defined as d-4, and
(d2+d3+d4)/(d-2+d-3+d-4)>1.

7. The electrode assembly as claimed in claim 1, wherein the winding interval in the winding front end area is about 340 μm to about 370 μm, and the winding interval in the winding rear end area is about 320 μm to about 339 μm.

8. The electrode assembly as claimed in claim 1, wherein, after a charge/discharge cycle of the electrode assembly, a height at the winding front end area increases by about 0.5 mm to about 2 mm.

9. The electrode assembly as claimed in claim 1, wherein, after a charge and discharge cycle of the electrode assembly, a perfect circle ratio in the winding front end area is about 95% to about 99%.

10. The electrode assembly as claimed in claim 1, wherein a height of the winding front end area is less than a height in the winding rear end area.

11. The electrode assembly as claimed in claim 1, further comprising an insulating tape attached to an end of the second electrode plate in the winding front end area.

12. A secondary battery, comprising:
an electrode assembly including a first electrode plate, a separator, and a second electrode plate in a wound structure, the wound structure having a cylindrical shape;
a cylindrical case accommodating the electrode assembly; and
a cap assembly sealing the cylindrical case,
wherein:
a winding front end area is at a beginning of the wound structure,
a winding rear end area is at an end of the wound structure, and
a winding interval in the winding front end area is different from a winding interval in the winding rear end area.

13. The secondary battery as claimed in claim 12, wherein:
the first electrode plate is electrically connected to the cap assembly through a first electrode tab, and
the second electrode plate is electrically connected to the cylindrical case through a second electrode tab.

14. The secondary battery as claimed in claim 13, wherein the cap assembly comprises:
a cap-up, a safety vent coupled to the cap-up;
a cap-down coupled to the safety vent and to which the first electrode tab is electrically connected; and
an insulating gasket between the cap-up, the safety vent, and the cylindrical case.

15. The secondary battery as claimed in claim 13, wherein the cap assembly comprises:
a rivet terminal to which the first electrode tab is electrically connected;
an insulating gasket coupled to an outside of the rivet terminal; and
a cap plate coupled to an outside of the insulating gasket and to the cylindrical case.

16. The secondary battery as claimed in claim 12, wherein:
the cap assembly comprises a cap plate covering a lower side of the case and a rivet terminal coupled by interposing an insulating gasket at an upper side of the cylindrical case,
the first electrode plate is electrically connected to the cylindrical case through a first current collector plate, and
the second electrode plate is electrically connected to the rivet terminal through a second current collector plate.

17. A method for manufacturing a secondary battery, the method comprising:
preparing an electrode assembly wound in a cylindrical shape in a state in which a first electrode plate, a separator, and a second electrode plate are stacked, the electrode assembly comprising a winding front end area, on which winding of the first electrode plate, the separator, and the second electrode plate begins, and a winding rear end area, on which winding of the first electrode plate, the separator, and the second electrode plate are ends;
accommodating the electrode assembly in a cylindrical case;
inserting a pusher into the cylindrical case to fix an upper end of the electrode assembly; and
pressing an upper end of the electrode assembly using the pusher, such that a winding interval in the winding front end area is different from a winding interval in the winding rear end area.

18. The method as claimed in claim 17, wherein the winding interval in the winding front end area is greater than the winding interval in the winding rear end area.

19. The method as claimed in claim 17, wherein:
the winding front end area comprises about 1 turn to about 5 turns in a direction oriented from a winding front end at which the winding begins to a winding end at which the winding is ended, and
the winding rear end area comprises about 1 turn to about 5 turns in a direction oriented from the winding rear end area at which the winding is ended to the winding front end area at which the winding begins.
